(19) United States
(12) Patent Application Publication
(10) Pub. No.: US 2026/0066943 A1
(43) Pub. Date: Mar. 5, 2026

(54) SYSTEM AND METHOD FOR LINEARIZING FREQUENCY MULTIPLIERS WITH CONSTRAINED TRANSMITTER BANDWIDTH

(71) Applicants: Ahmed BEN AYED, Waterloo (CA); Slim BOUMAIZA, Waterloo (CA)

(72) Inventors: Ahmed BEN AYED, Waterloo (CA); Slim BOUMAIZA, Waterloo (CA)

(21) Appl. No.: 19/259,028

(22) Filed: Jul. 3, 2025

Related U.S. Application Data
(60) Provisional application No. 63/688,031, filed on Aug. 28, 2024.

(51) Int. Cl. H04B 1/62; H04B 1/00; H04B 1/04; H04B 7/06

(52) U.S. Cl. CPC H04B 1/62; H04B 1/0071; H04B 1/04; H04B 7/0617; H04B 2001/0425

(57) ABSTRACT

Systems and methods are disclosed for utilizing frequency multiplier (FX) based transmitters to generate wideband, substantially distortion-free signals, when a transmitter operates under bandwidth constraints. A receiver is configured to acquire the feedback signal at the multiplier output. The systems and methods alleviate the bandwidth constraints of the receiver. Additionally, the invention includes a training methodology for estimating predistortion coefficients configured to operate under constrained transmitter and receiver bandwidth conditions.

This nonprovisional application claims priority to U.S. Provisional Application No. 63/688,031, which was filed on Aug. 28, 2024, and which is herein incorporated by reference.

### BACKGROUND OF THE INVENTION

### Field of the Invention

Embodiments of the disclosure relate to systems and methods for the use of frequency multipliers with constrained transmitter bandwidth. Accordingly, the present invention enables the generation of wide bandwidth, substantially distortion free signals at a frequency multiplier output. This is achieved by configuring a receiver to acquire the feedback signal at the multiplier output—the invention further alleviates the bandwidth constraints of the receiver. Disclosed hereinafter are details of a training method including but not limited to—a method for estimating predistortion coefficients configured to operate under constrained transmitter and receiver bandwidth conditions.

### Description of the Background Art

The rapid evolution of communication and sensing systems has led to an increasing demand for higher data rates and improved signal quality. Generating high-quality vector-modulated signals at millimeter-wave (mm-wave) and sub-terahertz (sub-THz) frequencies is challenging specially as data throughput, power, and efficiency requirements rise. This challenge becomes more pronounced near the transistor's maximum oscillation frequency (fmax), where limited gain, peak power, and efficiency restrict power amplifier (PA) based transmitters, primarily due to the low breakdown voltage and parasitic effects of deep sub-micron transistors. Previously reported attempts to use PA-based transmitters at these high frequencies have shown low output power and signal quality restricting them to low-order modulation and single carrier test signals.

Frequency multipliers (FXs) are employed to generate and transmit high-frequency radio frequency (RF) signals, providing an efficient means of producing such signals. FX-based transmitters offer significant advantages, such as simplifying the design requirements of essential transmitter components preceding the FX, including IQ modulators, amplifiers and filters, to operate at a lower intermediate frequency (IF). In addition, FX-based transmitters possess a unique capability to generate signals with carrier frequencies that can exceed the transistor's fₘₐₓ. However, FXs are inherently nonlinear and introduce non-negligible nonlinear distortion of the FX output signal. This limitation has confined the use of FX-based architectures to spectrally inefficient, constant-envelope signals, such as frequency-modulated continuous-wave (FMCW) or phase-modulated signals. An “outphasing” technique has been proposed in prior art to generate spectrally efficient modulated signals. However, this approach introduces its own challenges, notably the inherent bandwidth expansion of the out-phased signals.

Digital Predistortion (DPD) is a signal processing technique commonly used in wireless communication systems to compensate for the nonlinearities of power amplifiers (PAs). The effectiveness of DPD in mitigating distortions introduced by high-efficiency power amplifiers (PAs) is well established. Attempts have been made to extend DPD application to FXs driven by vector modulated signals. For example, two memoryless polynomial functions that compensate for the amplitude (AM-AM) and phase (AM-PM) distortions to linearize FXs have also been described in prior art. Despite the low complexity, these applications demonstrate limited linearization performance with relatively narrowband signals.

Alternatively, prior work has proposed a quadrupling memory polynomial-based DPD to linearize frequency quadruplers. This approach uses a cascade of two high complexity polynomial predistortion modules followed by a Dₜₕ root function. Further prior art proposes modelling the nonlinearity in FXs as a cascade of three blocks. The middle block being an ideal multiplier, with two nonlinear blocks before and after the ideal operation used to represent the nonidealities exhibited by FXs. Subsequently, a DPD matching the forward model structure and composed of a memoryless polynomial module, a Dₜₕ order root function, and a pruned Volterra series-based model are used to compensate for the unwanted nonlinear distortions. Despite the relatively good linearization results achieved, the approach requires a two or more cascade procedures that significantly increases the DPD system complexity, cost, power consumption and reduced reliability.

Another approach proposed in prior art involves using an additive error model to derive a predistortion (PD) function required for linearizing the FXs. The analysis showed that a pruned Volterra series-based model, preceded and followed by a Dₜₕ root function, is sufficient to achieve linearization. This approach has been validated through measurements on various FXs with different multiplication factors, driven by orthogonal frequency-division modulated (OFDM) signals with bandwidths up to 400 MHz.

While the aforementioned schemes have demonstrated the potential of DPD to linearize FXs, it is crucial to minimize the power overhead associated with implementing the DPD, transmitter and feedback receiver hardware, and the training algorithm-particularly as signal bandwidths increase to several hundred MHz. Unlike PA based transmitters, which typically require a front-end bandwidth of approximately five times the signal bandwidth, FX based transmitters require approximately greater than ten times the bandwidth due to spectral expansion associated with the Dₜₕ root function. Attempts to reduce the transmitter bandwidth below this threshold result in suboptimal linearization performance or divergence in the DPD function. Consequently, FX based transmitters require very high-speed digital-to-analog converters (DACs) and broader bandwidth requirements for the RF front end components. While speed and power advancements in component processing and DAC technology have helped alleviate the implementation burden of the DPD; high-speed power consumption, cost and system reliability required to generate the PD signal and capture the nonlinear FX output signal remains a significant challenge.

A similar challenge exists for the transmitter observation receiver (TOR) which provides a feedback path for the FX output signal. To reduce bandwidth requirements of TOR RF input components and reduce the sampling speed of the TOR Analog-to-Digital Converter (ADC), prior art describes a PD function based on spectral extrapolation and band division. The method includes forward modelling a constrained bandwidth received signal and an extrapolation solution which recovers the spectra outside the received signal bandwidth. The constructed extrapolated signal is used to train full-band and band-limited PD functions to correct for out-of-band and in-band errors, respectively. While the focus has been on reducing the ADC sampling rate, the method fails to reduce the DAC sampling rate for the FX. As previously mentioned, where a PA based system DAC typically operates at around 5 times the signal bandwidth, an FX based system DAC is generally required to operate at ten times the signal bandwidth to accommodate the spectral regrowth introduced by the Dₜₕ root function. Subsequently the high DAC sampling rate requirement exacerbates the practical deployment of DPD based solutions for FXs.

### SUMMARY OF THE INVENTION

Methods and systems for linearizing FXs and reducing the bandwidth requirements of the transmitter DAC, transmitter analog RF front end and the transmitter observation receiver (TOR) are disclosed in the present invention.

In accordance with the present invention there is provided a baseband processor configured and operable to process an algorithm used to linearize the frequency multipliers (FX). The present invention details a DPD based system and method for linearizing FX-based transmitters driven by vector modulated signals, operating within the constraints of limited RF front-end bandwidth and reduced transmit DAC sampling speed. The method formulates an additive error model for an FX driven by a Dₜₕ root function under bandwidth constraints to derive a DPD module and underlying DPD training to reduce the required ADC sampling rate of the transmitter observation receiver (TOR). According to one aspect of the present invention, an expression of the PD function is formulated under constrained transmitter and receiver bandwidths. Direct and indirect learning DPD modules are used to estimate the predistortion function coefficients under constrained transmitter and feedback receiver bandwidths.

Unless otherwise specified, when an element or component is described as being “connected to” or “coupled to” another element or component, it is understood that the connection can be either direct or indirect, with one or more intervening elements or components present. These terms broadly encompass scenarios where intermediate elements or components facilitate the connection between the two.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates an exemplary system for linearizing frequency multipliers configured according to embodiments of the present invention.

FIG. 2 illustrates the block diagram of a direct learning (DL) DPD module.

FIG. 3 illustrates the block diagram of an indirect learning (IL) DPD module.

FIG. 4 illustrates a first embodiment of the present disclosure, depicting system using one or more frequency multipliers. The transmitter observation receiver (TOR) provides a feedback path for the RF output signal using a Network block to capture one or more frequency multiplier output signal yₚ(t) and/or the far-field signal.

FIG. 5 illustrates a second embodiment of the present disclosure, depicting a hybrid beamforming system using DPD augmented FX arrays. One or more frequency multipliers produce a high frequency modulated continuous-wave (FMCW) or vector modulated signal/s coupled to a beamforming array antenna.

FIG. 6 illustrates a third embodiment of the present disclosure, depicting an all-digital beamforming system. An FX-based digital beamforming array includes per-antenna element DACs and DPD modules. One or more frequency multipliers produce a high frequency modulated continuous-wave (FMCW) or vector-modulated signal/s and coupled to a beamforming array antenna.

FIG. 7: Illustration of the resulting error due to constraining the Dₜₕ root function bandwidth on the output of an ideal doubler.

FIG. 8: Simulated ideal doubler output spectrum with different constrained square-root function bandwidth input signals.

FIG. 9: Effects of limiting the square root function's bandwidth on the output spectrum of an ideal frequency-doubler.

FIG. 10: NMSE between the ideal signal and the output of the FX for different multiplication orders.

FIG. 11: Simulated power spectral density (PSD) at the doubler output.

FIG. 12: PSD at the doubler output where the Dₜₕ root function output bandwidth is limited to BW_{TX}=5×BW.

FIG. 13: A system using a DPD module to linearize FXs with constrained transmitter and observation receiver bandwidth.

FIG. 14: PSD at a SpaceK™ frequency-doubler output when driven with a 200-MHz signal.

FIG. 15: Output spectra of a SpaceK™ frequency-doubler driven with a 400-MHz OFDM signal.

FIG. 16: Linearization results for a SpaceK™ frequency-doubler with output frequency centered around 25 GHz.

FIG. 17: Measured gain distortion (left) and phase distortion (right) of a SpaceK™ frequency-doubler driven with a 400 MHz OFDM signal.

FIG. 18: PSD at the HMC578 frequency-doubler output when driven with a 400-MHz signal.

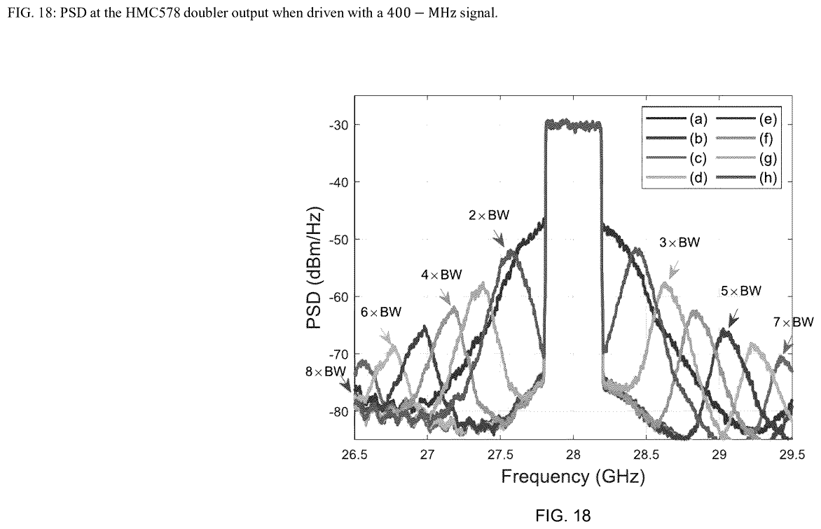

FIG. 19: Linearization results for the HMC578 frequency-doubler with output frequency centered around 28 GHz.

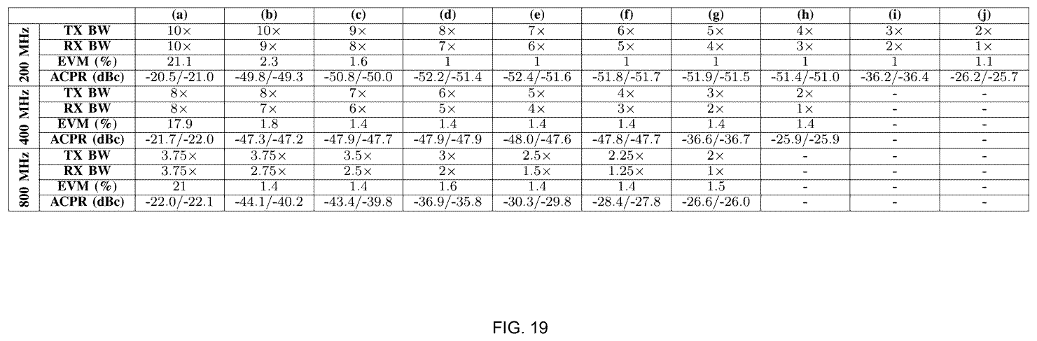

FIG. 20: PSD at the HMC578 frequency-doubler output when driven with a 800-MHz signal.

FIG. 21: Constellation at the HMC578 frequency-doubler output driven with an 800 MHz OFDM signal.

FIG. 22: Gain distortion (left) and phase distortion (right) of HMC578 frequency-doubler driven with an 800 MHz OFDM signal.

### DETAILED DESCRIPTION

Embodiments are illustrated by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

Disclosed is a system and method for linearizing FXs with constrained transmitter and feedback receiver bandwidths. Various embodiments of the disclosed PD method for frequency multipliers under constrained transmitter and feedback receiver bandwidths are applicable in a variety of settings, such as baseband system modelling, baseband predistortion, RF digital predistortion and other applications. Alternative embodiments may be applied to analog as well as digital signal predistortion. Other embodiments are readily evident to such skilled persons having the benefit of this disclosure. Reference will now be made in detail to implementations of the example embodiment as illustrated in the accompanying drawings. The same reference indicators will be used to the extent possible throughout the drawings and the following description to refer to the same or like items. In the interest of clarity, not all routine features of the implementations of the nonlinear system model described herein are shown and described. It will, of course, be appreciated that in actual deployment, numerous application-specific implementations are made to achieve specific goals, such as compliance with system-related constraints, and that these specific goals will vary from one implementation to another.

In accordance with this disclosure the constrained transmitter and feedback receiver DPD based training method for linearizing frequency multipliers described herein may be implemented in various types of nonlinear communication systems, such as radio frequency, optical and other types of communication systems.

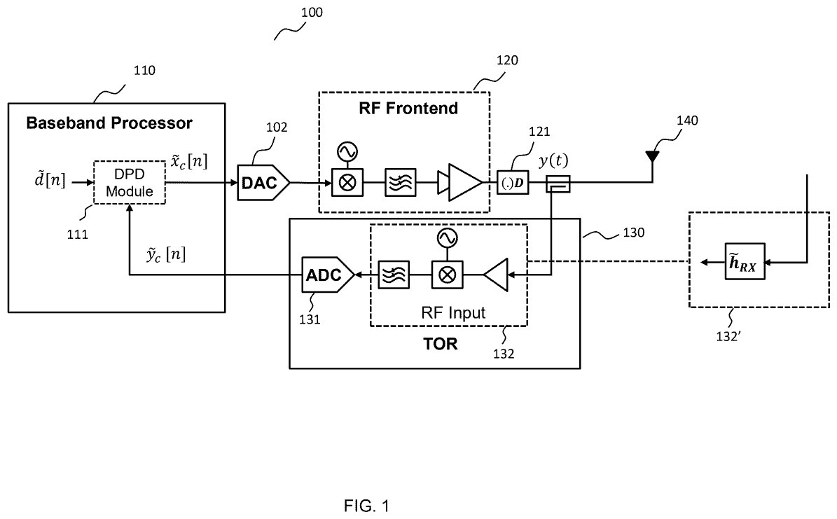

FIG. 1 illustrates an exemplary system 100 for linearizing FXs configured according to embodiments of the present invention. System 100 includes a baseband processor 110 configured and operable to generate a modulated signal coupled to a baseband digital-to-analog converter (DAC) 102 to produce a desired RF signal. DAC 102 is subsequently coupled to the transmitter RF frontend 120 to produce an IF modulated signal. The IF modulated signal is subsequently coupled to FX 121 to produce a high frequency modulated continuous-wave (FMCW) or vector-modulated signal. FX 121 is subsequently coupled to an antenna 140. Transmitter observation receiver (TOR) 130 provides a feedback path for the FX output signal y(t). TOR 130 includes an RF input block 132 and an Analog-to-Digital Converter (ADC) 131. An equivalent representation of RF input block 132 is shown as block 132′.

In an embodiment, baseband processor 101 comprises a processing unit configured and operable to process a DPD module 111. Baseband processor 101 may include a storage device, such as a random-access memory (RAM), read-only memory (ROM), electrically programmable ROM (EPROM), solid-state drive (SSD), and the like. Where a method comprising a series of process steps is implemented by the processing unit 101 and those process steps may be stored in said storage device as a series of instructions. Baseband processor 101 may also comprise an field programmable gate array (FPGA) configured and operable to drive the baseband DAC 102 to generate the desired RF signal. In addition, those of ordinary skill in the art will recognize that devices such as FPGAs, application specific integrated circuits (ASICs), digital signal processors (DSP) or the like, may also be used without departing from the scope and spirit of the inventive concepts disclosed herein.

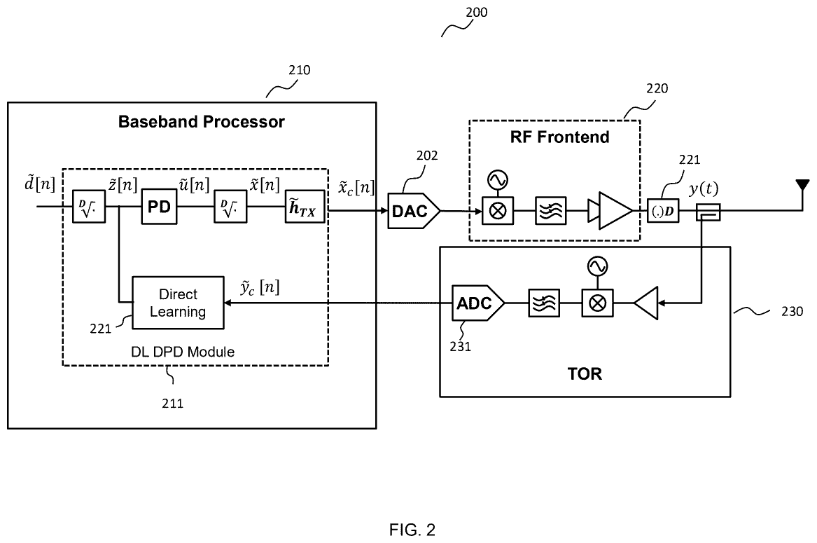

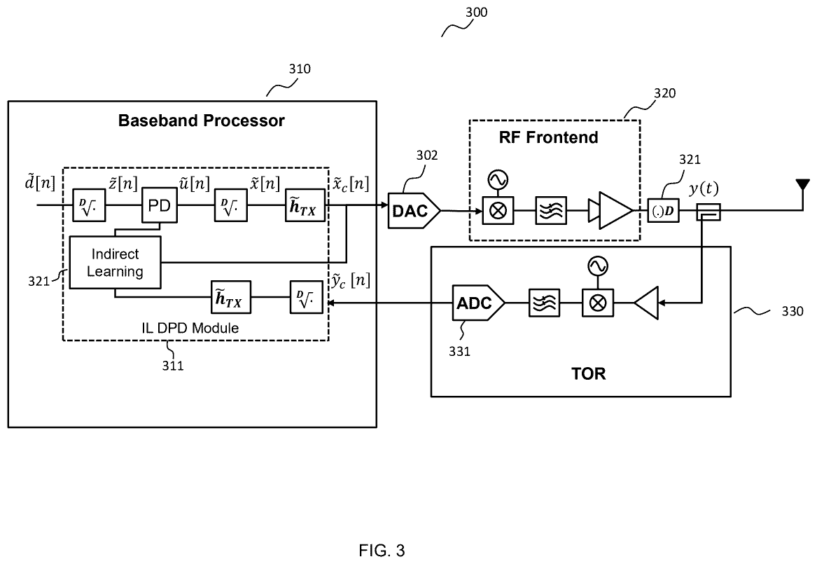

FIG. 2 and FIG. 3 illustrate an exemplary system 200 and 300 implementing direct and indirect learning DPD modules respectively; used to estimate the predistortion function coefficients under constrained transmitter and feedback receiver bandwidths. Direct and indirect learning DPD modules are further described in later paragraphs.

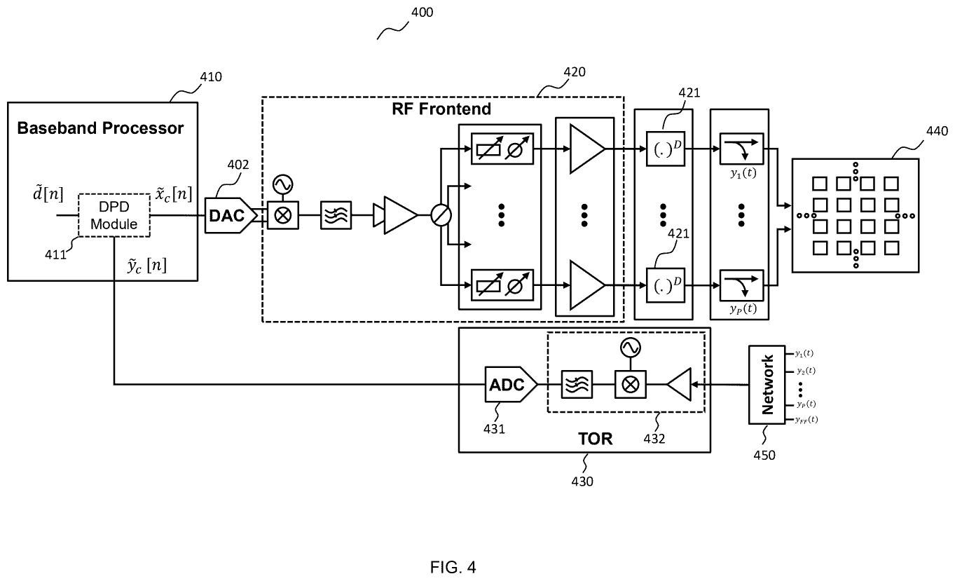

FIG. 4 illustrates a first embodiment of the present disclosure depicting a system 400 using one or more FXs 421. System 400 includes a baseband processor 410 configured and operable to generate a modulated signal coupled to a baseband digital-to-analog converters (DAC) 402 to produce a desired RF signal. Baseband processor 410 comprises a processing unit configured and operable to process a DPD module 411. DAC 402 is subsequently coupled to the transmitter RF frontend 420 to produce an IF modulated signal. The IF modulated signal is subsequently coupled to FX 421 to produce a high frequency modulated continuous-wave (FMCW) or vector-modulated signal. FX 421 is subsequently coupled to an antenna 440. TOR 430 includes an RF input block 432 and an ADC 431. TOR 430 provides a feedback path for the RF output signal using a Network block 450 to capture all or a subset of the FX 421 output signal yₚ(t). The network block 450 is implemented using one or more of an equal power combiner, a configurable weighted combiner and a switch for selecting among different output signal yₚ(t) observation paths.

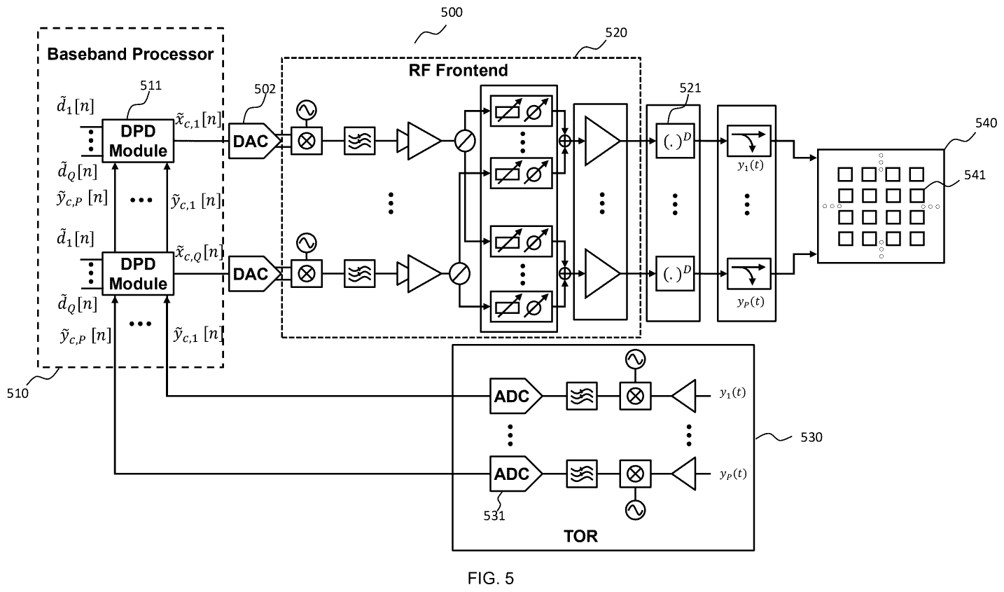

FIG. 5 illustrates a second embodiment of the present disclosure, depicting a hybrid beamforming system 500 using DPD augmented FX arrays. System 500 limits the distortions introduced by the nonlinear FXs 521. One or more frequency multipliers 521 produce a high frequency modulated continuous-wave (FMCW) or vector-modulated signal/s coupled to a beamforming array antenna 540. TOR 530 provides a feedback path for the RF output signal using one or more ADCs 531 to capture the frequency multiplier 521 output signal yₚ(t). The parameter “P” represents the number of antenna elements 541, and parameter “Q” represents the number of DAC 502 signal paths. DPD module 511 processes one or more baseband signals and generates the PD waveforms to linearize the desired radiated directions. DPD modules 511 are optimized for constrained transmitter RF frontend 520 and TOR 530 bandwidths. DPD training is performed using one or more of the FX 521 outputs and received far-field radiated signals within the constraints of the observation bandwidth.

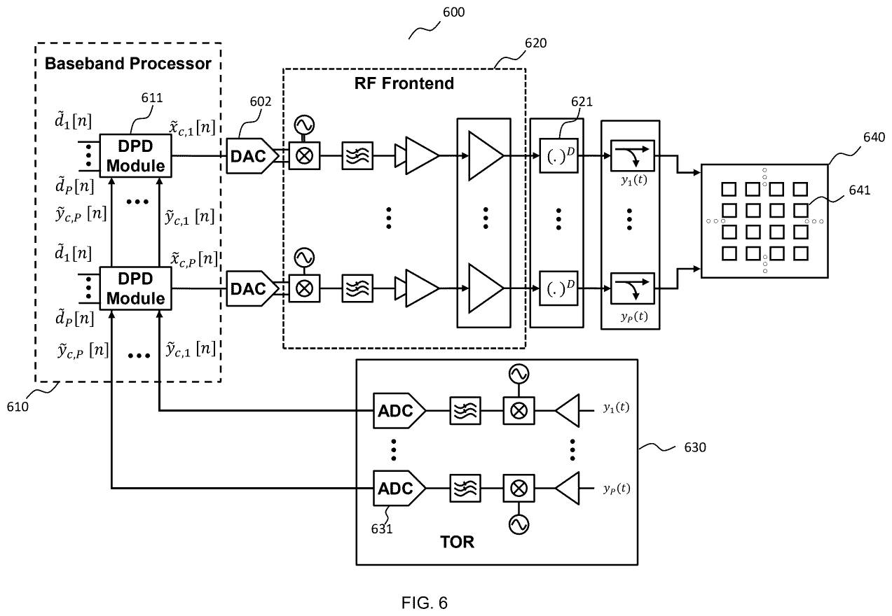

FIG. 6 illustrates a third embodiment of the present disclosure, depicting an all-digital beamforming system 600 using an FX-based digital beamforming array including per-element DACs 602 and DPD modules 611. One or more frequency multipliers 621 produce a high frequency modulated continuous-wave (FMCW) or vector-modulated signal/s are coupled to a beamforming array antenna 640. TOR 630 provides a feedback path for the RF output signal using one or more ADCs 631 to capture the frequency multiplier 621 output signal yₚ(t). Parameter “P” represents the number of antenna elements 641. The number of antenna elements 641 (P) matches the number of digital inputs, reflecting an all digital configuration. DPD modules 611 operate under the same constraints as in the hybrid case, compensating for nonlinearities in view of the limited bandwidth of both the transmitter RF frontend 620 and the TOR 630. Modules 611 are trained using one or more FX 621 outputs, radiated antenna elements 641 output signal and received radiated far-field signals within the constraints of the observation bandwidth.

In a further embodiment, variations of the aforementioned embodiments use FXs configured within the RF front-end before a power amplifier.

In a further embodiment, variations of the aforementioned embodiments use FXs configured at an input of the antenna array.

In a further embodiment, variations of the aforementioned embodiments use FXs a configured at an intermediate stage of the RF frontend transmitter.

In describing the present invention, it will be understood that several techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The following paragraphs describe the details of the DPD module 111, 211 and 311 for linearizing FX-based transmitters with constrained bandwidths as shown in FIGS. 1,2 and 3.

Let \tilde{h}_{TX}=(\tilde{h}_{TX}[0], . . . , \tilde{h}_{TX}[P′]) be the impulse response of the transmitter bandwidth limiting filter, with length P′+1, and let the cascade of the Dₜₕ root function, \tilde{h}_{TX}, and the non-ideal FX be the nonlinear system to be linearized by a predistortion (PD) function. In the following, the expression of the PD function needed to linearize said cascade is described.

Let ũ[n] be the output of the PD, \tilde{x}[n] be the output of the Dₜₕ root function, \tilde{x}_{c}[n] be the output of the transmitter bandwidth limiting filter, \tilde{h}_{TX} [n], and \tilde{y}[n] be the output of the FX. The bandwidth of the constrained input signal to the multiplier, \tilde{x}_{c}[n], is expressed as follows;

$${\tilde{x}}_{c} [ n ] = {\sum }_{m = 0}^{{P}^{′}} \tilde{x} [ n - m ] {\tilde{h}}_{T X} [ m ] , where \tilde{x} [ n ] = \sqrt[D]{\tilde{u} [ n ]} . \qquad ( 1 )$$

Alternatively, using a block of N+1 samples, (1) is expressed in matrix form as,

$${\tilde{x}}_{c} [ n ] = {\tilde{H}}_{T X}^{0} \tilde{x} ( n ) \qquad ( 2 )$$

$$= {\tilde{H}}_{TX}^{0} \sqrt[D]{\tilde{u} [ n ]} , \qquad ( 3 )$$

where \tilde{x}(n)=(\tilde{x}[n], . . . , \tilde{x}[n−N])^{T},

$${\tilde{H}}_{T X}^{i}$$

is a row vector defined as,

$${\tilde{H}}_{T X}^{i} = \{ \begin{matrix}( {0}_{i} , {\tilde{h}}_{TX} , {0}_{N - P - i} ) & 0 \leq i \leq N - {P}^{′} \\ ( {0}_{i} , {\tilde{h}}_{TX} ( 0 : N - i ) ) ) & N - P < i \leq N\end{matrix} \qquad ( 4 )$$

$$\sqrt[D]{\tilde{u} [ n ]} = {( \sqrt[D]{\tilde{u} [ n ]} , … , \sqrt[D]{\tilde{u} [ n - N ]} )}^{T} ,$$

and 0ᵢ is a 1×i zero vector.

Using an additive error model, the frequency multiplier output \tilde{y}[n] is expressed as follows,

$$\tilde{y} [ n ] = {\tilde{x}}_{c}^{D} [ n ] + \tilde{e} ( {\tilde{x}}_{c} ( n ) ) , \qquad ( 5 )$$

where the nonlinear error term, \tilde{e}(\tilde{x}_{c}((n)), takes the form of the frequency multiplier forward model given by,

$$\tilde{e} ( {\tilde{x}}_{c} ( n ) ) = \qquad ( 6 )$$

$${\sum }_{p = 0}^{{N}_{L}} {γ}_{m}^{{p}_{1} , {p}_{2} , ℓ} {\prod }_{i = 1}^{{p}_{1}} {\tilde{x}}_{c} [ n - {m}_{i} ] {\prod }_{j = 1}^{{p}_{2}} {\tilde{x}}_{c}^{*} [ n - {\hat{m}}_{j} ] , \qquad ( 7 )$$

$$where ,$$

$$( p ) = \{ ( {p}_{1} , {p}_{2} ) ∈ {ℤ}^{2} \vert {p}_{1} \geq 0 , {p}_{2} \geq 0$$

$${p}_{1} + {p}_{2} = p , {p}_{1} - {p}_{2} = D \}$$

is the set of tuples (p₁, p₂) that results in a nonlinearity order of p, the set [symbol] ={0, 1, 2, . . . , M}, M is the maximum memory depth, N_{L} is the maximum nonlinearity order and [symbol] are the model coefficients. \tilde{y}[n] is expressed as a function of the PD output, ũ[n], as,

$$\tilde{y} [ n ] = {( {\tilde{H}}_{TX}^{0} \sqrt[D]{\tilde{u} ( n )} )}^{D} + \tilde{e} ( {\tilde{H}}_{TX} \sqrt[D]{\tilde{u} ( n )} ) , \qquad ( 9 )$$

$$where ,$$

$${\tilde{H}}_{T X} = [ \begin{matrix}{\tilde{H}}_{T X}^{0} \\ {\tilde{H}}_{T X}^{1} \\ ⋮ \\ {\tilde{H}}_{T X}^{N}\end{matrix} ] , \qquad ( 10 )$$

is an upper triangular matrix with nonzero diagonal elements. Alternatively, (9) is rewritten as follows,

$$\tilde{y} [ n ] = \tilde{u} [ n ] + {( {\tilde{H}}_{TX}^{0} \sqrt[D]{\tilde{u} ( n )} )}^{D} + {\tilde{e}}^{′} ( {\tilde{H}}_{TX} \sqrt[D]{\tilde{u} ( n ) )} \qquad ( 11 )$$

$$where ,$$

$${\tilde{e}}^{′ ( {\tilde{H}}_{T X} \sqrt[D]{\tilde{u} ( n )} )} = {( {\tilde{H}}_{T X} \sqrt[D]{\tilde{u} ( n )} )}^{D} - \tilde{u} [ n ] , \qquad ( 12 )$$

is the error due to the constrained bandwidth Dₜₕ root function. Note, the error

$${\tilde{e}}^{′} ( {\tilde{H}}_{T X} \sqrt[D]{\tilde{u} ( n )} )$$

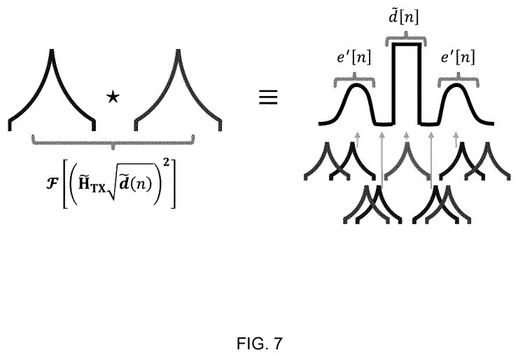

cannot be corrected by the PD and is mainly dominant in the out-of-band away from the signal bandwidth shown in FIG. 7. Let the sampled complex envelop of the FX output signal after receiver bandwidth limiting be, \tilde{y}_{c}[n], where

$${\tilde{y}}_{c} [ n ] = {\sum }_{m = 0}^{{P}^{′}} \tilde{y} [ n - m ] {\tilde{h}}_{R X} [ m ] , \qquad ( 13 )$$

and \tilde{h}_{RX}=(\tilde{h}_{RX}[0], . . . , \tilde{h}_{RX}[P″]) is the impulse response of the TOR RF input (FIG. 1 132′) filtering at the frequency multiplier output with length equal P″+1. The bandwidth of \tilde{h}_{RX}[n], denoted as BW_{RX}, is used to reduce the required sampling speed for the TOR ADC 131 and is assumed to filter out the out-of-band distortions that result from limiting the Dₜₕ root function bandwidth. Results on the choice of BW_{RX} that satisfy the aforementioned assumption are presented in the simulation section described in later paragraphs. Alternatively, (13) is expressed in matrix form as follows,

$${\tilde{y}}_{c} [ n ] = {\tilde{H}}_{R X}^{0} \tilde{y} ( n ) , \qquad ( 14 )$$

where \tilde{y}(n)=(ÿ[n], . . . , \tilde{y}[n−N])^{T}, and

$${\tilde{H}}_{R X}^{i} = \{ \begin{matrix}( {0}_{i} , {\tilde{h}}_{RX} , {0}_{N - {P}^{′} - i} ) & 0 \leq i \leq N - {P}^{″} \\ ( {0}_{i} , {\tilde{h}}_{RX} ( 0 : N - i ) ) & N - {P}^{′} < i \leq N\end{matrix} \qquad ( 15 )$$

Substituting (11) in (14) we have,

$${\tilde{y}}_{c} [ n ] = {\tilde{H}}_{R X}^{0} ( \tilde{u} ( n ) + \tilde{e} ( {\tilde{H}}_{TX} \sqrt[D]{\tilde{u} ( n )} ) + {\tilde{e}}^{′} ( {\tilde{H}}_{TX} \sqrt[D]{\tilde{u} ( n )} ) ) \qquad ( 16 )$$

$$where ,$$

$$\tilde{e} ( {\tilde{H}}_{TX} \sqrt[D]{\tilde{u} ( n )} ) = [ \begin{matrix}\tilde{e} ( {\tilde{H}}_{TX} \sqrt[D]{\tilde{u} ( n )} ) \\ \tilde{e} ( {\tilde{H}}_{TX} \sqrt[D]{\tilde{u} ( n - 1 )} ) \\ ⋮ \\ \tilde{e} ( {\tilde{H}}_{TX} \sqrt[D]{\tilde{u} ( n - N )} )\end{matrix} ] \qquad ( 17 )$$

$$and ,$$

$${\tilde{e}}^{′} ( {\tilde{H}}_{TX} \sqrt[D]{\tilde{u} ( n )} ) = [ \begin{matrix}{\tilde{e}}^{′} ( {\tilde{H}}_{TX} \sqrt[D]{\tilde{u} ( n )} ) \\ {\tilde{e}}^{′} ( {\tilde{H}}_{T} D \sqrt[D]{\tilde{u} ( n - 1 )} ) \\ ⋮ \\ {\tilde{e}}^{′} ( {\tilde{H}}_{TX} \sqrt[D]{\tilde{u} ( n - N )} )\end{matrix} ] \qquad ( 18 )$$

Assuming that the out-of-band error due to limiting the Dₜₕ root function bandwidth is filtered by the receive filter, \tilde{h}_{RX}[n], and is negligible within the passband of \tilde{h}_{RX}[n], i.e,

$${\tilde{H}}_{R X}^{0} {\tilde{e}}^{′} ( {\tilde{H}}_{TX} \sqrt[D]{\tilde{u} ( n )} ) \approx 0 \qquad ( 19 )$$

the following approximation is made,

$${\tilde{y}}_{c} [ n ] \approx {\tilde{u}}_{c} [ n ] + {\tilde{H}}_{R X}^{0} \tilde{e} ( {\tilde{H}}_{TX} \sqrt[D]{\tilde{u} ( n )} ) \qquad ( 20 )$$

$$where ,$$

$${\tilde{u}}_{c} [ n ] = {\tilde{H}}_{R X}^{0} \tilde{u} ( n ) .$$

Further, if the PD compensates for the frequency multiplier nonlinearity, \tilde{y}_{c}[n] in (20) will be equal to the desired input signal, \tilde{d}[n], convolved with the impulse response of the receiver filter, \tilde{h}_{RX}[n], i.e.,

$${\tilde{y}}_{c} [ n ] = {\tilde{H}}_{R X}^{0} \tilde{d} ( n ) . \qquad ( 22 )$$

Consequently, from (20), the constrained bandwidth predistortion signal, ũ_{c}[n], is expressed as a function of the desired and error signals as follows,

$${\tilde{u}}_{c} [ n ] = {\tilde{H}}_{R X}^{0} \tilde{d} ( n ) - {\tilde{H}}_{R X}^{0} \tilde{e} ( {\tilde{H}}_{TX} \sqrt[D]{\tilde{u} ( n )} ) \qquad ( 23 )$$

Alternatively, (23) is expressed in vector form as follows,

$${\tilde{u}}_{c} ( n ) = {\tilde{H}}_{R X} \tilde{d} ( n ) - {\tilde{H}}_{R X} \tilde{e} {\tilde{( H}}_{TX} \sqrt[D]{\tilde{u} ( n )} ) \qquad ( 24 )$$

$$where ,$$

$${\tilde{H}}_{R X} = [ \begin{matrix}{\tilde{H}}_{R X}^{0} \\ {\tilde{H}}_{R X}^{1} \\ ⋮ \\ {\tilde{H}}_{R X}^{N}\end{matrix} ] . \qquad ( 25 )$$

is an upper triangular matrix with nonzero diagonal elements and thus invertible, i.e.,

$${\tilde{H}}_{R X} {\tilde{H}}_{R X}^{- 1} = I .$$

Using (21) and the fact that \tilde{H}_{RX} is invertible we have,

$$\tilde{u} ( n ) = {\tilde{H}}_{R X}^{- 1} {\tilde{u}}_{c} ( n ) \qquad ( 26 )$$

$$= \tilde{d} ( n ) - \tilde{e} {\tilde{( H}}_{TX} \sqrt[D]{\tilde{u} ( n )} ) \qquad ( 27 )$$

Substituting (27) in (23), we get,

$${\tilde{u}}_{c} [ n ] = {\tilde{H}}_{R X}^{0} \tilde{d} ( n ) - {\tilde{H}}_{R X}^{0} \tilde{e} ( {\tilde{H}}_{T X} \sqrt[D]{\tilde{d} ( n ) - \tilde{e} ( {\tilde{H}}_{T X} \sqrt[D]{\tilde{u} ( n )} )} ) \qquad ( 28 )$$

Assuming that the contribution of the “error of the error” in (28) is negligible, the following approximation is made,

$$\tilde{e} ( {\tilde{H}}_{T X} \sqrt[D]{\tilde{d} ( n ) - \tilde{e} ( {\tilde{H}}_{T X} \sqrt[D]{\tilde{u} ( n )} )} ) \approx \tilde{e} ( {\tilde{H}}_{T X} \sqrt[D]{\tilde{d} ( n )} ) \qquad ( 29 )$$

Hence, (28) is rewritten such that,

$${\tilde{u}}_{c} [ n ] = {\tilde{H}}_{R X}^{0} \tilde{d} ( n ) - {\tilde{H}}_{R X}^{0} \tilde{e} ( {\tilde{H}}_{T X} \sqrt[D]{\tilde{d} ( n )} ) \qquad ( 30 )$$

Let [symbol] denote the set of all forward model basis functions in (7) and [symbol] enumerate the basis functions in [symbol] . Then the error term,

$$\tilde{e} ( {\tilde{H}}_{T x} \sqrt[D]{\tilde{d} ( n )} ) ,$$

in (30) is rewritten compactly as,

$$\tilde{e} ( \tilde{z} ( n ) ) = {w}_{ℓ} {\tilde{ψ}}_{ℓ} ( \tilde{z} ( n ) ) \qquad ( 31 )$$

where w [symbol] is the model coefficient corresponding to the [symbol] th model basis, [symbol] , \tilde{z} (n)=(\tilde{z}[n], \tilde{z}[n−1], . . . , \tilde{z}[n−N])^{T}, and

$$\tilde{z} [ n ] = {\tilde{H}}_{TX} \sqrt[D]{\tilde{d} ( n )} .$$

Alternatively, (31) is expressed in matrix form as,

$$\tilde{e} ( \tilde{z} ( n ) ) = {\tilde{Ψ}}_{n} w \qquad ( 32 )$$

where, w=(w₀, . . . , w_{L})^{T}, \tilde{Ψ}ₙ is the basis matrix with i th column and j th row entry given by \tilde{ψ}ᵢ(\tilde{z}(n−j)), and,

$$\tilde{e} ( \tilde{z} ( n ) ) = [ \begin{matrix}\tilde{e} ( \tilde{z} ( n ) ) \\ \tilde{e} ( \tilde{z} ( n - 1 ) ) \\ ⋮ \\ \tilde{e} ( \tilde{z} ( n - N ) )\end{matrix} ] . \qquad ( 33 )$$

Substituting (32) in (30), we have,

$${\tilde{u}}_{c} [ n ] = {\tilde{H}}_{RX}^{0} \tilde{d} ( n ) - {\tilde{H}}_{RX}^{0} {\tilde{Ψ}}_{n} w \qquad ( 34 )$$

Finally, using (12) and the approximation in (19), i.e.,

$${\tilde{H}}_{RX}^{0} \tilde{d} ( n ) \approx {\tilde{H}}_{RX}^{0} ( {\tilde{H}}_{TX} \sqrt[D]{\tilde{d} ( n )} ) \qquad ( 35 )$$

then (34) is rewritten more compactly as,

$${\tilde{u}}_{c} [ n ] = {\tilde{H}}_{RX}^{0} {\tilde{Ψ}}_{n} a \qquad ( 36 )$$

where a=(1−w₀, . . . , −α_{L}) are the predistorter coefficients and without loss of generality, it is assumed that \tilde{ψ}₁ (\tilde{z}(n))=(\tilde{z}(n))^{D}.

The objective of the DPD module is to minimize the error between the DPD module input signal \tilde{d}[n] and the FX multiplier output \tilde{y}[n]. For this, the error between the DPD module input signal \tilde{d}[n] convoluted with \tilde{h}_{RX}[n] and the multiplier constrained output \tilde{y}_{c}[n] is minimized;

$$J ( a ) = {\sum }_{n = M + 1}^{L} ( {\tilde{y}}_{c} [ n ] - {\tilde{H}}_{RX}^{0} \tilde{d} ( n ) ) {( {\tilde{y}}_{c} [ n ] - {\tilde{H}}_{RX}^{0} \tilde{d} ( n ) )}^{H} \qquad ( 37 )$$

where L is the length of the training data, and a is the vector of DPD coefficients that are to be optimized to minimize the cost function J. Using (36), and the direct learning DPD module 211, the optimal choice of a is iteratively calculated and the coefficients are obtained by the update equation,

$${\hat{a}}_{k + 1} = {\hat{a}}_{k} - {μ ( {\tilde{H}}_{RX} {\tilde{Ψ}}_{{n}_{k}} )}^{†} ( {\tilde{y}}_{c} ( {n}_{k} ) - {\tilde{H}}_{RX} \tilde{d} ( {n}_{k} ) ) \qquad ( 38 )$$

where âₖ are the estimated DPD coefficients at the k^{th} iteration, μ>0 is the update step size, and (·)^{†} is the pseudo inverse operator such that,

$${( {\tilde{H}}_{RX} {\tilde{Ψ}}_{{n}_{k}} )}^{†} = {( {( {\tilde{H}}_{RX} {\tilde{Ψ}}_{{n}_{k}} )}^{H} ( {\tilde{H}}_{RX} {\tilde{Ψ}}_{{n}_{k}} ) )}^{- 1} ( {\tilde{H}}_{RX} {\tilde{Ψ}}_{{n}_{k}} ) \qquad ( 39 )$$

Alternatively, it is possible to use the indirect leaning DPD module 311 to find the optimal choice of a iteratively using the following update equation,

$${\hat{a}}_{k + 1} = {( {\tilde{H}}_{RX} {\tilde{Φ}}_{k} )}^{†} {\tilde{H}}_{RX} {\tilde{x}}_{c}^{D} ( {n}_{k} ) \qquad ( 40 )$$

where \tilde{Φ}ₖ is the basis matrix with i th column and j th row entry given by

$${\tilde{ψ}}_{i} ( {\tilde{H}}_{T} \sqrt[D]{{\tilde{y}}_{c} [ {n}_{k} + j ]} ) .$$

The diagrams of the described constrained transmitted and receiver feedback bandwidths using the indirect learning DPD module is shown in FIG. 7. The updated predistorter output signal, ũ[nₖ₊₁], at time index n and in the k+1 iteration is then given as follows,

$$\tilde{u} [ {n}_{k + 1} ] = {\tilde{Ψ}}_{{n}_{k + 1}} {a}_{k + 1} \qquad ( 41 )$$

Hence, together (36), (39), (40), and (41) comprise the iterative training process that identifies the predistortion coefficients.

Simulation results are presented as follows. The simulation results demonstrate how limiting the bandwidth of the Dₜₕ root function impacts the output spectrum of an ideal FX system. The linearization performance of the described DPD module on an EM-simulated frequency-doubler is also described.

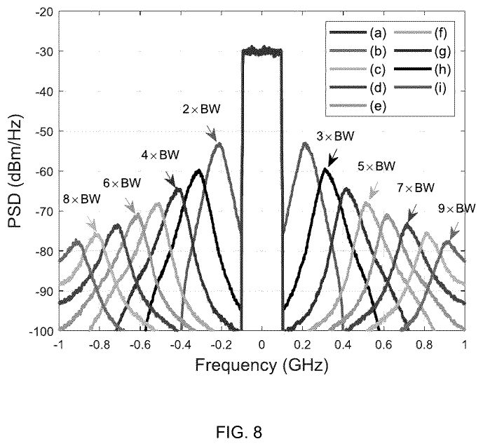

The bandwidth of the transmitter filter, \tilde{h}_{TX}[n], used for constraining the Dₜₕ root function, is represented as BW_{TX}, while the ideal signal bandwidth (i.e., the bandwidth of the signal input to the Dₜₕ root function is represented as BW. FIG. 8 illustrates the simulated output spectra of an ideal doubler: (a) with ideal square-root function input signal and (b)-(i) with constrained bandwidth square-root function where the bandwidth is swept from 9×BW down to 2×BW, with a step on 1×BW. FIG. 8, illustrates that constraining the Dₜₕ root function bandwidth results in spectrum regrowth in the signal adjacent bands. Furthermore, the maximum magnitude of the generated distortions is inversely proportional to the constrained Dₜₕ root function bandwidth, B_{WTX}. These distortions are the result of the time-domain power function characteristic of FXs, which manifest as a convolution in the frequency domain and is illustrated in FIG. 7.

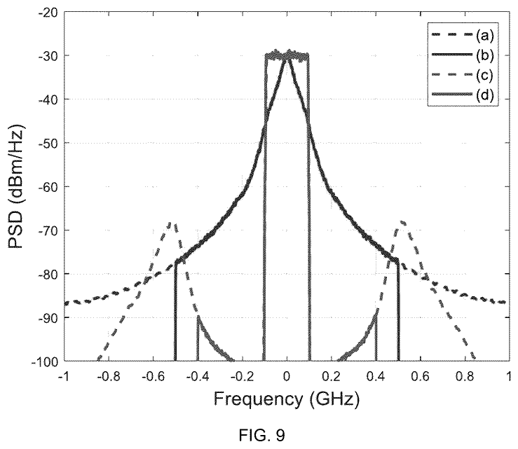

FIG. 9 illustrates the effects of limiting the square root function's bandwidth on the output spectrum of an ideal frequency-doubler; (a) spectrum of the ideal square-root function, (b) spectrum of the square-root function constrained to 5×BW, and (c) output spectrum of an ideal multiplier when driven by the 5×BW constrained square-root function. As shown in FIG. 9, the most substantial distortions resulting from constraining the square-root function bandwidth appear at ±(BW_{TX}/2). In order to filter out the out-of-band error,

$${\tilde{e}}^{′} ( {\tilde{H}}_{TX} \sqrt[D]{\tilde{u}} ( n ) )$$

a filter with bandwidth BW_{RX} is used to diminish the constraints on the receiver ADC sampling rate and satisfy the assumption in (18). The value of BW_{RX} used is represented as follows:

$${BW}_{RX} = {BW}_{TX} - BW . \qquad ( 42 )$$

FIG. 9 (d), illustrates the output spectra of an ideal doubler when driven with a square-root function constrained to a bandwidth of 5×BW shown in (b) after applying the receive filter with bandwidth, BW_{RX}=4×BW. This filtering operation significantly reduces the out-of-band error due to the constrained square-root function bandwidth. Comparing the filtered spectrum with the unfiltered case, the residual error, quantified in terms of normalized mean square error (NMSE), is greatly reduced from −40.4 to −69.1 dB. This result provides robust support for the assumption made in (19), affirming that distortions originating from transmitter bandwidth constraints predominantly manifest in the out-of-band spectrum, specifically around ±(BW_{TX}/2), with negligible impact on the in-band portion of the signal. It is noteworthy that these conclusions also apply to FXs when D>2.

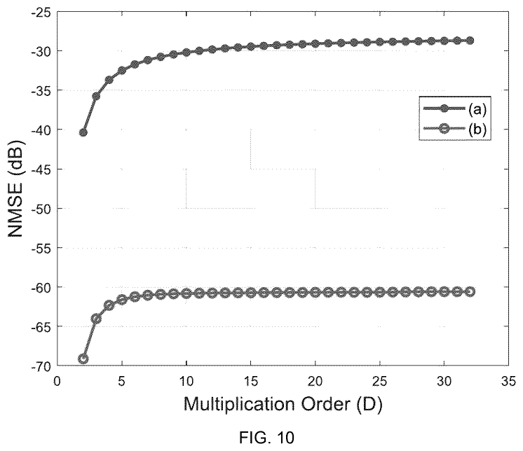

FIG. 10 illustrates, for different multiplication orders (D), the NMSE between the ideal signal and the output of the FX; (a) before and (b) after applying receiver filtering (BW_{RX}=4×BW). For this, the Dₜₕ root output signal bandwidth is limited to BW_{TX}=5×BW. Here it is evident that the application of the filter significantly reduces the NMSE, highlighting that the distortions attributed to limiting the bandwidth at the output of the Dₜₕ root function are predominantly in the out-of-band spectrum. This validates the assumption made in (20) across different multiplication orders (D).

The following simulation results illustrate linearization of the disclosed DPD module on an EM 60 GHz output frequency-doubler in a stacked push-push configuration. The doubler is uses 45 nm CMOS SOI technology and simulated using Advanced Design System (ADS) software. The simulated AM-AM and AM-PM are used to generate a look-up-table (LUT)-based forward model for the doubler which is then used to train the DPD module. The test signal used in the simulation is a 200 MHz orthogonal frequency-division multiplexing (OFDM) signal with subcarriers modulated using 256-quadrature amplitude modulation (QAM) and a peak-to average power ratio (PAPR) of 9 dB.

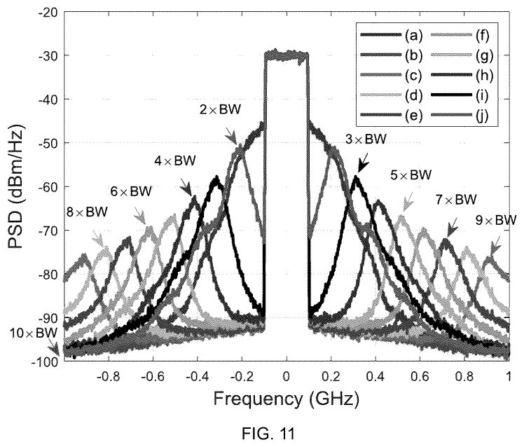

FIG. 11 illustrates the simulated power spectral density (PSD) at the doubler output; (a) before DPD with ideal square-root function applied and (b)-(j) after the described DPD module with constrained square-root function and observation receiver bandwidth swept from BW_{TX}=10×BW and BW_{RX}=9×BW in (b), down to BW_{TX}=2×BW and BW_{RX}=1×BW in (j), respectively, with a step of 1×BW. Using the disclosed DPD module, the error vector magnitude (EVM) improved from 20.7% before DPD in (a) to 0.4% in (b)-(i), and to 0.6% in (j). Similarly, the adjacent channel power ratio (ACPR) after DPD improved from −21.3/−21.5 dBc in (a), to better than 60 dBc in (b)-(g), −58.2/−58.2 dBc in (h), −36.9/−37.4 dBc in (i), and −25.8/−25.9 dBc in (j). The DPD coefficients used in the simulation were obtained using the direct learning DPD module in (38) and a total of 30 coefficients were used. Note, the deterioration in the ACPR results reported in (i) and (j) are attributed to the out-of-band error, \tilde{e}′[n], caused by the constrained bandwidth square-root function, leading to peak distortion at ±(3/2)BW in (i) and ±BW in (j). Note that this error does not significantly impact the in-band signal quality, as evidenced by the EVM after DPD remaining at 0.4% in (i) and slightly increasing to 0.6% in (j).

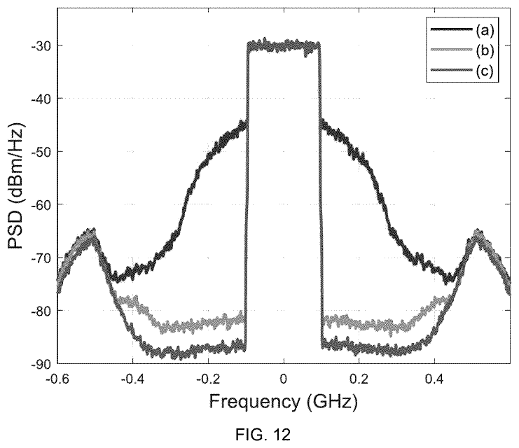

The linearization efficacy of the disclosed DPD module is described as follows. The DPD parameters, including nonlinearity order, memory depth, and the number of coefficients, are kept the same for the simulations. In addition, the number of DPD iterations is fixed to 10. FIG. 12 shows the PSD at the doubler output where the Dₜₕ root function output bandwidth is limited to BW_TX=5×BW (a) before DPD with the Dₜₕ root function applied, (b) after DPD to adapt it to FXs and the TOR bandwidth constrained to BW_{RX}=5×BW and (c) after application the disclosed DPD module with TOR bandwidth set according to (40), i.e., BW_{RX}=4×BW. Here it is evident that the disclosed method significantly outperforms alternatives by achieving approximately 6-8-dB improvement in the adjacent channel power leakage ratio.

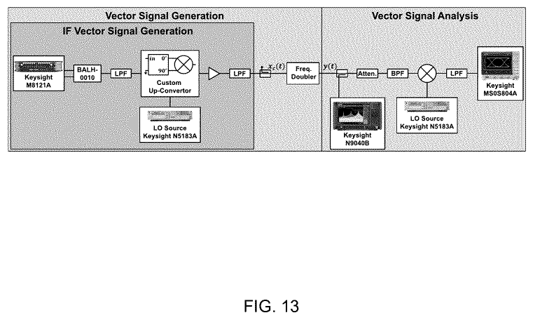

FIG. 13 illustrates a system using the disclosed DPD module to linearize FXs with constrained transmitter and observation receiver bandwidth. Two different frequency-doublers (D=2) are used: 1) a frequency-doubler with output centered at 25 GHz from SpaceK Labs (A2510-2x-20), and 2) a frequency-doubler with output centered at 28 GHz from Analog Devices (HMC-578). The vector-modulated test signals were generated using a 12-bit, 12-GS/s arbitrary waveform generator (M8121A from Keysight Technologies™), with output centered at an IF of 1.75 GHz. A custom upconverter consisting of a variable attenuator (HMC-624), a driver amplifier (HMC788A), a hybrid-90 (IPP-4120), and an IQ-mixer (MMIQ 1037 H from Marki Microwave™) is used to up-convert the IF signal to a center frequency of 12.5 GHz for the first frequency-doubler and 14 GHz for the second frequency-doubler case. The signal was then amplified using a driver amplifier (MAAM-011109 from MACOM™). Afterward, a lowpass filter (LPF) (FLP-1250 from Marki Microwave™) for the first frequency-doubler and a custom filter for the second frequency-doubler are used to reject the residual image and local oscillator (LO) leakage before being fed to the doubler under test. The output of the frequency-doubler is then fed to a directional coupler, followed by a receiver (N9040B from Keysight) connected to its coupled port. The through signal from the directional coupler is then down-converted to an IF frequency of 3.025 GHz using an IF-mixer (MM-11140H) and captured using a 10-bit, 20-Gs/s, 8-GHz analog bandwidth oscilloscope (MSOS804A from Keysight Technologies™). LO sources (MXG-N5183B from Keysight Technologies™) are used to drive the up conversion and down conversion mixers used in the system.

Measurements are performed using 200, 400, and 800 MHz modulation bandwidth OFDM signals conforming to 3GPP 5G NR downlink specifications, with subcarriers modulated using 256-QAM, subcarrier spacing of 120 kHz, total data subcarriers K_{D} of 1584, 3168, and 6336, and fast Fourier transform sizes K_{FFT} of 2048, 4096, and 8192, for the 200, 400, and 800-MHz signals, respectively. The test signals are characterized by a PAPR (after crest factor reduction using clipping and filtering) of 9 dB. The 200, 400, and 800 MHz test signals are complex sampled at 2 and 4 G/ps, respectively. For the DPD, the nonlinearity order, nonlinear memory depth, linear memory depth, memory step, and pruning parameters were set to 20, 5, 5, 8, and 2, respectively, resulting in a total of 30 coefficients. The number of iterations used to train the DPD function was fixed to 10, and 1.5×10⁴ samples were used per iteration for DPD training.

The EVM per OFDM symbol is defined as follows:

$$EVM = \frac{{\sum }_{k = 0}^{{K}_{D}} {\vert {\tilde{y}}_{FFT} ( {v}_{k} ) W ( {v}_{k} ) - {\tilde{d}}_{FFT} ( {v}_{k} ) \vert}^{2}}{{\sum }_{k = 0}^{{K}_{D}} {\vert {\tilde{d}}_{FFT} ( {v}_{k} ) \vert}^{2}} \qquad ( 43 )$$

where \tilde{y}_{FFT} and \tilde{d}_{FFT} are the discrete-time Fourier transform of the time-aligned sampled complex envelopes of the received and ideal signals, respectively. Furthermore, K_{D} is the total number of data subcarriers, vₖ is the k th data subcarrier discrete-time Fourier transform index, and W(·) is the transfer function of the linear equalization filter and is obtained from K_{D} OFDM pilot subcarriers

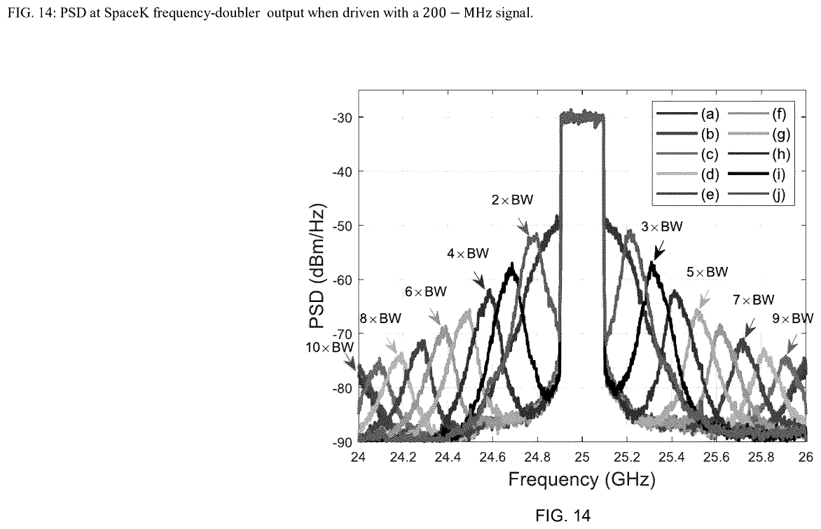

FIG. 14 shows the PSD at the SpaceK frequency-doubler output when driven with a 200-MHz signal; (a) before DPD with square-root function applied BW_{TX}=10×BW and BW_{RX}=10×BW, and (b)-(j) after the described DPD with constrained square-root function output and observation receiver bandwidth swept from BW_{TX}=10×BW and BW_{RX}=9×BW in (b), down to BW_{TX}=2×BW and BW_{RX}=1×BW in (j), respectively, with a step of 1×BW. Using the disclosed DPD module, the EVM improved from 13.6% before DPD in (a) to 1% in (d)-(i), and to 1.1% in (j). Similarly, the ACPR after DPD improved from −24.4/−24.5 dBc in (a), to better than-50 dBc in (b)-(h), −36.4/−37.1 dBc in (i), and −26.0/−26.3 dBc in (j).

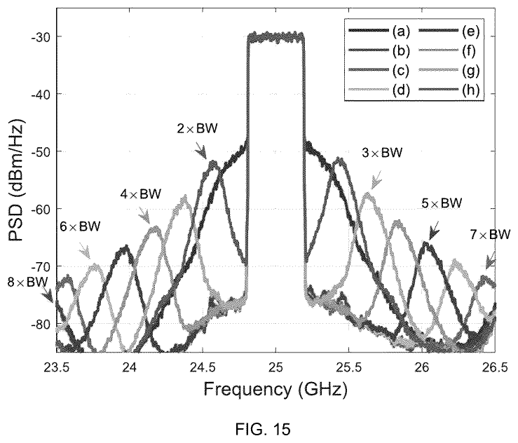

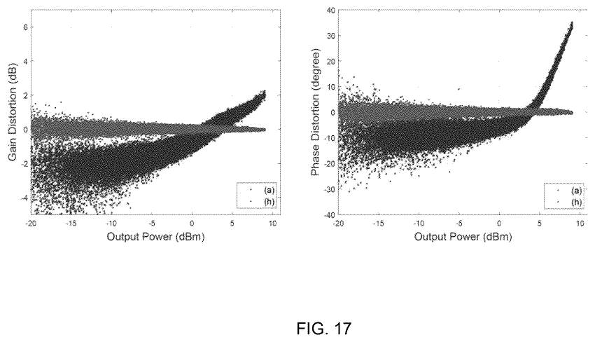

Similar linearization results were reported for the 400 MHz case. FIG. 15 shows the PSD at the SpaceK frequency-doubler output when driven with a 256-QAM 400 MHz OFDM signal (a) before DPD with square-root function applied, BW_{TX}=8×BW and BW_{RX}=8×BW and (b)-(h) after the described DPD with constrained square-root function output and receiver bandwidths swept from BW_{TX}=8×BW and BW_{RX}=7×BW in (b), down to BW_{TX}=2×BW and BW_{RX}=1×BW in (h), respectively, with a step of one. FIG. 17 shows the gain (AM-AM) (left) and phase (AM-PM) (right) distortion characteristics, respectively, at the SpaceK frequency-doubler output corresponding to the measurements presented in FIG. 15, (a) and (h).

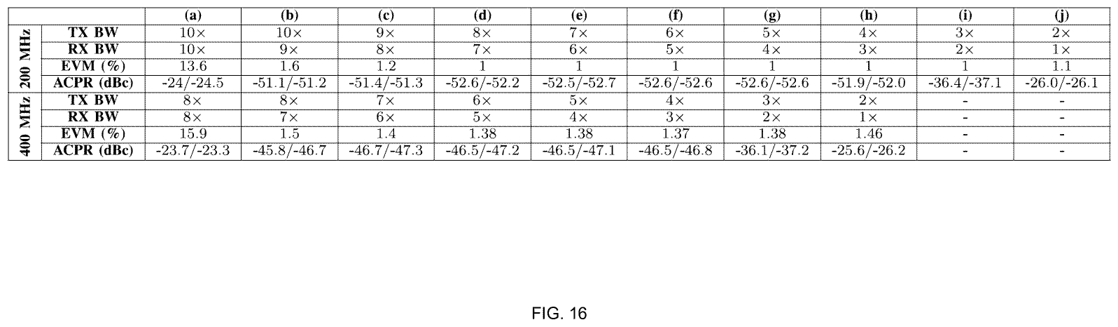

The linearization results for the SpaceK frequency-doubler are summarized in FIG. 16. Using the disclosed DPD module, the EVM improved from 15.9% before DPD in (a) to below 1.4% in (c)-(g) and to 1.46% in (h). Similarly, the ACPR after DPD exhibited substantial enhancement, decreasing from −23.7/−23.3 dBc in (a), to as low as −46.7/−47.3 dBc in (c). Note that a minor deterioration in EVM and ACPR results are shown in (b), compared with (d)-(h), for both the 200- and 400-MHz test signal cases, respectively. These are attributed to transmitter calibration errors. Specifically, in the 200-MHz test case, when using a BW_{TX}=10×BW and BW_{RX}=9×BW in (b), transmitter calibration at the frequency-doubler input would necessitate ensuring error-free signal over a wider bandwidth, i.e., BW_{TX}=10×BW, compared with when the transmitter bandwidth is constrained to BW_{TX}<10×BW. Achieving such wideband calibration is challenging in practice. Consequently, in addition to reducing the transmitter and observation receiver data converters sampling rates, constraining the bandwidth of Dₜₕ root function output has the added benefit of relaxing the transmitter calibration requirements, where the calibration bandwidth needs to match BW_{TX}. Moreover, the deterioration in the ACPR results when BW_{TX} and BW_{RX} were set to less than 3×BW and 2×BW, respectively, is attributed to the out-of-band error, \tilde{e}′[n], due to the constrained bandwidth square-root function output, leading to peak distortion at ±(3/2)BW and ±BW, respectively. While this error cannot be rectified by the DPD, its impact on in-band signal quality remains negligible. This is exemplified in the EVM after DPD being maintained at 1% in (i) and 1.38% in (g) for the 200 and 400 MHz test signals respective when BW_{TX}=3×BW and BW_{RX}=2×BW. In addition, there is a marginal increase in EVM to 1.1% in (i) and 1.46% in (h) for the 200- and 400 MHz signals respective, when BW_{TX}=2×BW and BW_{RX}=1×BW.

Despite this marginal increase in EVM, the disclosed DPD method was able to mitigate the FX's nonlinear distortion as illustrated by the flat AM-AM and AM-PM curves in FIG. 17(h). Furthermore, for BW_{TX}>3×BW and BW_{RX}≥2×BW the achieved ACPR and EVM remained compliant with the 3GPP requirements for FR2 frequencies operating in the n257 band for 256-QAM OFDM signals which specify a maximum EVM of 3.5% and a maximum ACPR of −28 dBc for 256-QAM OFDM signals. Moreover, for BW_{TX}>2×BW and BW_{RX}≥1×BW the achieved ACPR and EVM remained compliant with the 3 GPP requirements for FR2 frequencies operating in the n260 band for 256-QAM OFDM signals which specify a maximum EVM of 3.5% and a maximum ACPR of −26 dBc for 256-QAM OFDM signals. These results align with the previously described simulation results.

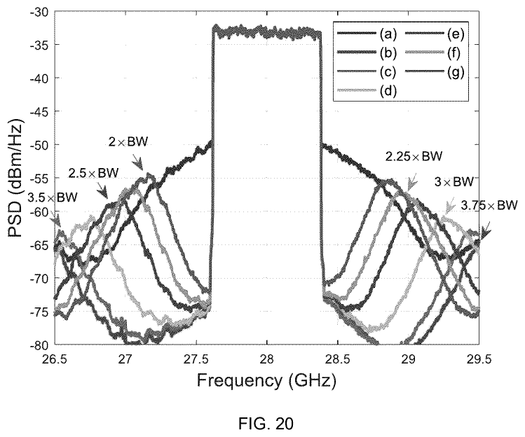

The generality of the disclosed DPD method for linearizing frequency-doublers with contained transmitter and observation receiver bandwidth, a second frequency-doubler (HMC578 from Analog Devices) is driven in higher compression, i.e., using worse starting ACPR and EVM. The measurement results for the HMC578 doubler are summarized in FIG. 20.

Similar to the first frequency-doubler case, FX linearization is achieved using the disclosed DPD method across different transmitter and observation receiver bandwidth configurations. FIG. 20 shows the PSD at the HMC578 frequency-doubler output when driven with a 400-MHz signal (a) before DPD with square-root function applied BW_{TX}=8×BW and BW_{RX}=8×BW and (b)-(h) after the disclosed DPD method with constrained square-root function output and observation receiver bandwidth ranging from BW_{TX}=8×BW and BW_{RX}=7×BW in (b), down to BW_{TX}=2×BW and BW_{RX}=1×BW in (h), respectively, with a step size of 1×BW. Using the described DPD scheme, the EVM improved significantly, reducing from 17.9% before DPD in (a) to 1.8% in (b) and 1.4% in (c)-(h). Likewise, the ACPR after DPD improved from −21.0/−22.0 dBc in (a), to better than −47 dBc in (b)-(f) and as reaching as low as −47.9/−47.9 dBc in (d). The measurement results further demonstrate the effectiveness of the described DPD in linearizing FXs with constrained transmitters and observation receivers bandwidths.

In addition to the capacity of the described DPD to reduce the transmitter and observation receive required bandwidths for linearizing FXs, it also enables the generation of wider bandwidth signals without compromising the ability to linearize the device under test. FIG. 20 shows the PSD at the HMC578 doubler output when driven with a 800-MHz signal (a) before DPD with square-root function applied BW_{TX}=3.75×BW and BW_{RX}=3.75×BW and (b)-(g) after the described DPD with constrained square-root function output and observation receiver bandwidth swept from BW_{TX}=3.75×BW and BW_{RX}=2.75×BW in (b), down to BW_{TX}=2×BW and BW_{RX}=1×BW in (g), respectively.

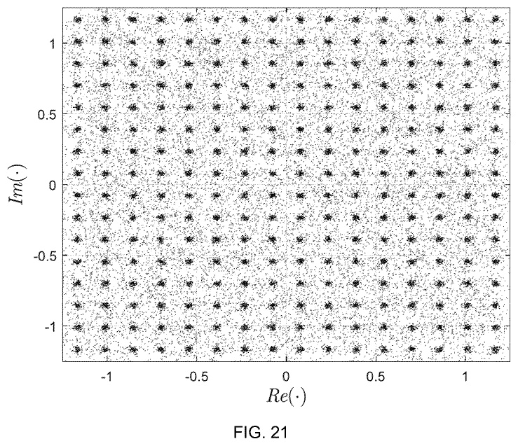

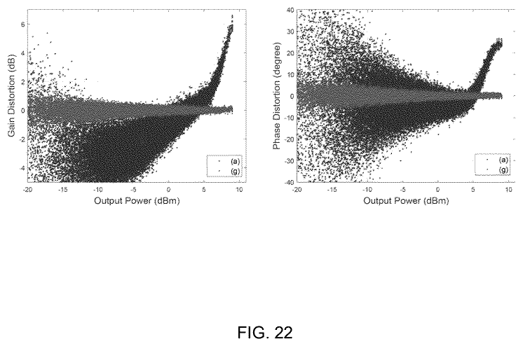

FIG. 22 shows the gain distortion (left) and phase distortion (right) of HMC578 frequency-doubler driven with an 800 MHz OFDM signal, corresponding to the measurements presented in FIG. 20, (a) and (g). Furthermore, the constellation plot corresponding to the results in FIG. 20, (a) and (g), is shown in FIG. 21. Using the described DPD scheme, the EVM significantly improved from 21% before DPD in (a) to 1.4% in (b), (c), (e), and (f), and to 1.5% in (g). Similarly, the ACPR after DPD improved from −22.7/−22.1 dBc in (a), to as good as −44.0/−40.2 dBc in (b). Furthermore, when the transmitter and observation receiver bandwidth are limited to BW_{TX}=2×BW and BW_{RX}=1×BW, respectively, the described DPD is still effective in mitigating the FX's nonlinearity. This is highlighted by the flat AM-AM and AM-PM plots in FIG. 22, (g), and the negligible distortion in the constellation plot in FIG. 22 (blue). Note, when employing transmitter and observation receiver bandwidth as low as BW_{TX}=2.25×BW and BW_{RX}=1.25×BW, respectively, the achieved ACPR and EVM remained compliant with the 3GPP requirements for FR2 frequencies operating in the n257 band for 256-QAM OFDM signals which specify a maximum EVM of 3.5% and a maximum ACPR of −28 dBc for 256-QAM OFDM signals. Moreover, for BW_{TX}=2×BW and BW_{RX}=1×BW the achieved ACPR and EVM remained compliant with the 3GPP requirements for FR2 frequencies operating in the n260 band for 256-QAM OFDM signals which specify a maximum EVM of 3.5% and a maximum ACPR of −26 dBc for 256-QAM OFDM signals.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A radio frequency (RF) transmitter for generating modulated signals at millimeter-wave (mm-wave) and sub-terahertz (sub-THz) frequencies comprising:
a baseband processor configured and operable to generate one or more modulated signals;
one or more digital pre-distortion (DPD) modules for processing the one or more modulated signals;
one or more baseband digital-to-analog converters (DAC) coupled to the baseband processor configured and operable to produce one or more RF signals;
one or more transmitter RF frontends coupled to the one or more baseband digital-to-analog converters (DAC) to produce one or more intermediate frequency (IF) modulated signals;
one or more frequency multipliers (FX) coupled to the one or more transmitter RF frontends configured and operable to generate one or more one or more linearized, substantially distortion free FX output radio frequency (RF) signals; and
a transmitter observation receiver (TOR) configured and operable to provide a feedback path for the one or more FX output radio frequency (RF) signals to the baseband processor,
wherein the one or more transmitter RF frontends operate under bandwidth constraints.

2. The system of claim 1, wherein processing the one or more FX output radio frequency (RF) signals includes a direct learning function.

3. The system of claim 1, wherein processing the one or more FX output radio frequency (RF) signals includes an indirect learning function.

4. The system of claim 1, further comprising a one or more transmitter RF frontends coupled to a beamforming array antenna.

5. The system of claim 4, further comprising a network block configured and operable to provide a feedback path for the FX output radio frequency (RF) signals to the transmitter observation receiver (TOR), wherein the network block includes one or more of an equal power combiner, a configurable weighted combiner and a switch for selecting one or more FX output radio frequency (RF) signals.

6. The system of claim 4, further comprising a transmitter observation receiver (TOR) coupled to the one or more frequency multipliers (FX), wherein the number of the one or more digital pre-distortion (DPD) modules are matched with the number of one or more digital-to-analog converters (DAC) to produce the one or more intermediate frequency (IF) modulated signals.

7. The system of claim 4, further comprising a transmitter observation receiver (TOR) coupled to the one or more frequency multipliers (FX), wherein the number of one or the more digital pre-distortion (DPD) modules are matched with the number of one or more beamforming array antenna elements to produce the one or more intermediate frequency (IF) modulated signals.

8. A method for generating radio frequency (RF) modulated signals at millimeter-wave (mm-wave) and sub-terahertz (sub-THz) frequencies, the method comprising:
generating one or more modulated signals using a baseband processor;
processing the one or more modulated signals using one or more digital pre-distortion (DPD) modules;
generating one or more RF signals using one or more baseband digital-to-analog converters (DAC);
generating one or more intermediate frequency (IF) modulated signals using one or more transmitter RF frontends;
generating one or more one or more linearized, substantially distortion free FX output radio frequency (RF) signals using one or more frequency multipliers (FX); and
providing a feedback path for the one or more FX output radio frequency (RF) signals to the baseband processor using a transmitter observation receiver (TOR),
wherein the one or more transmitter RF frontends operate under bandwidth constraints.

9. The method of claim 8, further comprising processing the one or more FX output radio frequency (RF) signals using a direct learning function.

10. The method of claim 8, further comprising processing the one or more FX output radio frequency (RF) signals using an indirect learning function.

11. The method of claim 8, further comprising the one or more transmitter RF frontends controlling a beamforming array antenna.

12. The method of claim 11, further comprising a network block providing a feedback path for the FX output radio frequency (RF) signals to the transmitter observation receiver (TOR), wherein the network block includes one or more of an equal power combiner, a configurable weighted combiner and a switch for selecting the one or more FX output radio frequency (RF) signals.

13. The method of claim 11, wherein processing using a number of one or more digital pre-distortion (DPD) modules is matched to a number of one or more baseband digital-to-analog converters (DAC) generating the one or more RF signals.

14. The method of claim 11, wherein processing using a number of more the digital pre-distortion (DPD) modules is matched to a number of one or more beamforming array antenna elements generating the one or more intermediate frequency (IF) modulated signals.
